(19) United States
(12) Patent Application Publication
(10) Pub. No.: US 2012/0271651 A1
(43) Pub. Date: Oct. 25, 2012

(54) Systems, Methods, And Media Providing An Integrated Timecard, Quality Assurance, And Claim Submission Service

(76) Inventors: Michael J. Gilbert, Natick, MA (US); Christopher W. Jenkins, Stow, MA (US); Doris E. Kraemer, Lexington, MA (US)

(21) Appl. No.: 13/451,514

(22) Filed: Apr. 19, 2012

Related U.S. Application Data
(60) Provisional application No. 61/477,125, filed on Apr. 19, 2011.

(51) Int. Cl. G06Q 50/22; G06Q 40/08

(52) U.S. Cl. 705/2

(57) ABSTRACT

An integrated timecard, quality assurance, and claim submission service helps manage and ensure that a care recipient is receiving care from a caregiver in accordance with a pre-established plan of care and that claim submissions are generated and transmitted to an insurance company or other payer(s) completely, accurately, and compatibly for straight-through processing. The service automatically verifies the hours and days worked and the activities performed by a caregiver, identifies any discrepancies, and adheres to the claim submission requirements of the care recipient's insurance company and/or other payer(s). In some embodiments, a payroll preparation process is also provided to help manage payments to caregivers.

### CROSS REFERENCE TO RELATED APPLICATION

This claims the benefit of U.S. Provisional Patent Application No. 61/477,125, filed Apr. 19, 2011, which is hereby incorporated by reference herein in its entirety.

### TECHNICAL FIELD

The disclosed subject matter relates to systems, methods, and media for providing an integrated timecard, quality assurance, and claim submission service directed to the administration of care for a care recipient.

### BACKGROUND

The process of administering a plan of care for a care recipient, which may be a family member or relative, can be a daunting and burdensome task. Such a process may involve keeping track of hours and days worked and activities performed each week by one or more independent or home care agency caregivers, and then checking that information against the plan of care to identify and resolve any discrepancies or deficiencies. Such a process may further include the daunting and burdensome tasks of recordkeeping, preparation of forms and documentation, and submission of claims to insurance companies and/or other payers of the care provided, such as, for example, government entities and/or their designated representatives or organizations. Moreover, all of this may need to be done unexpectedly when, for example, a sudden illness or injury of a family member or relative occurs.

### SUMMARY

Systems, methods, and media providing an integrated timecard, quality assurance, and claim submission service directed to the administration of a plan of care for a care recipient are disclosed. The service may include a timecard process to be used by caregivers of the care recipient. The service may also include a quality assurance process that may verify information received by the timecard process from one or more caregivers, and may identify any discrepancies in the received information and between the received information and the plan of care. The service may further include a claims submission process that may generate and transmit claim submission information to insurers or other payer(s) (which may include government entities and/or government-appointed entities) based on information received by the timecard process and/or any additional information entered by a user that supplements, corrects, updates, verifies, acknowledges, and/or approves the information received by the timecard process. The claims submission process may customize the generation and transmission of claim information according to an insurer's or payer's requirements, which may include, but is not limited to, required documents and forms, data/file formats, transmission interfaces and protocols, and/or schedules.

In some embodiments, the service may optionally include a payroll process that may generate payroll information for compensating a caregiver. The payroll process may run automatically based on information received by the timecard process and/or any additional information entered by a user that supplements, corrects, updates, verifies, acknowledges, and/or approves the timecard process information. The payroll process may include generation of payroll information related to withholdings, direct deposit, payment of taxes and fees, year-end statements and filings, and/or any other related services.

In accordance with some embodiments, a method for implementing the integrated timecard, quality assurance, and claim submission service may include storing in one or more storage devices information regarding a plan of care for a care recipient. Caregiver information associated with the plan of care may also be stored in the one or more storage devices. The method may also include receiving at one or more hardware processors check-in/check-out information initiated by a caregiver regarding caregiver services provided to a care recipient. At least one hardware processor may have interactive voice response and/or voice recognition/pattern matching capabilities. In some embodiments, the received check-in/check-out information may include automatically generated information, such as, for example, a time/date stamp. The method may further include the one or more hardware processors determining whether the received check-in/check-out information is complete and/or whether the received check-in/check-out information conforms to the stored information regarding the plan of care and/or the stored caregiver information and/or whether a pattern related to the received check-in/check-out information is questionable and/or unacceptable. The method may still further include the one or more hardware processors (1) notifying a user of one or more discrepancies in the received check-in/check-out information; (2) receiving at the one or more hardware processors information resolving the one or more discrepancies to create updated check-in/check-out information; (3) receiving approval of the received check-in/check-out information (if no discrepancies are found) or the updated check-in/check-out information; (4) generating claim submission information in accordance with a care recipient's insurer's or payer's requirements; and/or (5) transmitting the claim submission information to the insurer or payer in accordance with the insurer's or payer's requirements. In some embodiments, the generation of claim submission information may alternatively occur automatically (i.e., without the one or more hardware processors receiving approval) in response to the one or more hardware processors determining that there are no discrepancies in the received check-in/check-out information.

In accordance with some embodiments, a system for implementing the integrated timecard, quality assurance, and claim submission service may include (1) one or more storage devices for storing information regarding a plan of care for a care recipient and for storing caregiver information associated with the plan of care, and (2) one or more hardware processors coupled to the one or more storage devices. In some embodiments, at least one of the hardware processers may have interactive voice response and/or voice recognition/pattern matching capabilities. The one or more hardware processors may be operative to receive check-in/check-out information initiated by a caregiver regarding caregiver services provided to the care recipient. In some embodiments, the received check-in/check-out information may include automatically generated information, such as, for example, location information. The location information may include, for example, a source telephone number as provided by a caller identification (caller ID) service, an Internet protocol (IP) address, or global positioning system (GPS) information. In some embodiments, the one or more hardware processors may be operative to determine whether the received check-in/check-out information is complete and/or whether the received check-in/check-out information conforms to the stored information regarding the plan of care and/or the stored caregiver information and/or whether a pattern related to the received check-in/check-out information is questionable and/or unacceptable. In some embodiments, the one or more hardware processors may be operative to (1) notify a user of one or more discrepancies in the received check-in/check-out information; and (2) receive information from the user resolving the one or more discrepancies to create updated check-in/check-out information. In some embodiments, the one or more hardware processors may be operative to (1) generate claim submission information based on the received check-in/check-out information or the updated check-in/check-out information in accordance with an insurer's or payer's requirements; and (2) transmit the claim submission information to the insurer or payer of the caregiver services in accordance with that insurer's or payer's requirements.

In accordance with some embodiments, a non-transitory computer readable medium containing computer-executable instructions that, when executed by a processor, may cause the processor to implement a method of the integrated timecard, quality assurance, and claim submission service. The method may include: (1) receiving check-in/check-out information initiated by a caregiver regarding caregiver services provided to a care recipient; (2) determining whether the received check-in/check-out information is complete and/or in conformance with stored information regarding a plan of care and/or caregiver information associated with the plan of care and/or whether a pattern related to the received check-in/check-out information is questionable and/or unacceptable; (3) notifying a user of one or more discrepancies in the received check-in/check-out information; (4) receiving information resolving the one or more discrepancies to create updated check-in/check-out information; (5) generating claim submission information based on the received check-in/check-out information or the updated check-in/check-out information in accordance with an insurer's or payer's requirements; and/or (6) transmitting the claim submission information to the insurer or payer of the caregiver services in accordance with the insurer's or payer's requirements.

### BRIEF DESCRIPTION OF THE DRAWINGS

FIG. 1 is a diagram illustrating a system for implementing an integrated timecard, quality assurance, and claim submission service in accordance with some embodiments;

FIG. 2 is a diagram illustrating another system for implementing an integrated timecard, quality assurance, and claim submission service in accordance with some embodiments;

FIG. 3 is a flow diagram illustrating a process for implementing an integrated timecard, quality assurance, and claim submission service in accordance with some embodiments;

FIG. 4 is a flow diagram illustrating a telephonic check-in/check-out procedure of a timecard process in accordance with some embodiments;

FIG. 5 is an illustrative display screen of a timecard process report indicating discrepancies as determined by one or more hardware processors in accordance with some embodiments; and

FIG. 6 is a flow diagram illustrating another process for implementing an integrated timecard, quality assurance, and claim submission service in accordance with some embodiments of the invention.

### DETAILED DESCRIPTION

Systems, methods, and media for providing an integrated timecard, quality assurance, and claim submission service are disclosed. In some embodiments, these systems, methods, and media may help families and/or others manage the care of a care recipient in accordance with a pre-established plan of care. In some embodiments, the care recipient may be, for example, an elderly, disabled, or injured family member that needs assistance with everyday living activities such as dressing, bathing, and feeding, either in the care recipient's home or in a care facility. In some embodiments, a plan of care may specify the living activities that a care recipient is to be assisted with by a caregiver. Certain living activities may be referred to as “ADLs” (activities of daily living) and may include bathing, dressing, eating, transferring, mobility, toileting, and maintaining continence. Certain other living activities may be referred to as “IADLs” (instrumental activities of daily living) and may include housekeeping, shopping, meal preparation, companionship, etc. In some embodiments, a plan of care may specify the number of hours per day and days per week during which the caregiver is to provide that assistance. A caregiver may be, for example, an independent care provider (such as a private home health aide), an employee of a home care agency, an employee of an assisted living facility, a family member or relative, or an informal care provider. A plan of care may be preapproved by an insurance company (e.g., a long-term health care insurer) or other payer (e.g., a government entity such as Medicare or Medicaid or a government-appointed entity) in some embodiments.

An integrated timecard, quality assurance, and claim submission service in some embodiments may be used in a variety of situations. For example, such a service may be used for administering the long term care of an individual in the individual's home, where the individual has a long-term care insurance policy. An employer/client of the service in this situation may be the individual policyholder, the payer may be the long-term care insurer, and the caregiver may be, for example, an independent care provider, an agency caregiver, family member, or relative. The service may also be used for administering care under Medicaid's self-directed care program. Here, the employer/client of the service may be the Medicaid recipient receiving care in the home, the payer may be the Medicaid recipient's state Medicaid program, and the caregiver may be an independent care provider. Similarly, the service may be used for administering care under Medicaid's home and community based service waiver program. The employer/client of the service may again be the Medicaid recipient receiving care in the home, the payer may be the state Medicaid program, and the caregiver may be an independent care provider, family member, or relative. The service may also be used for administering care under Medicaid's assisted living waiver program. In this situation, the employer/client may be the Medicaid recipient receiving care in a licensed assisted living facility, the payer may be the recipient's state Medicaid program, and the caregiver may be an independent care provider and/or staff of the assisted living facility. The service may further be used for administering care under a disability or workers' compensation insurance program. The employer/client of the service may be an injured worker or other individual, the payer may be a private insurer, and the caregiver may be an independent care provider, family member, or relative.

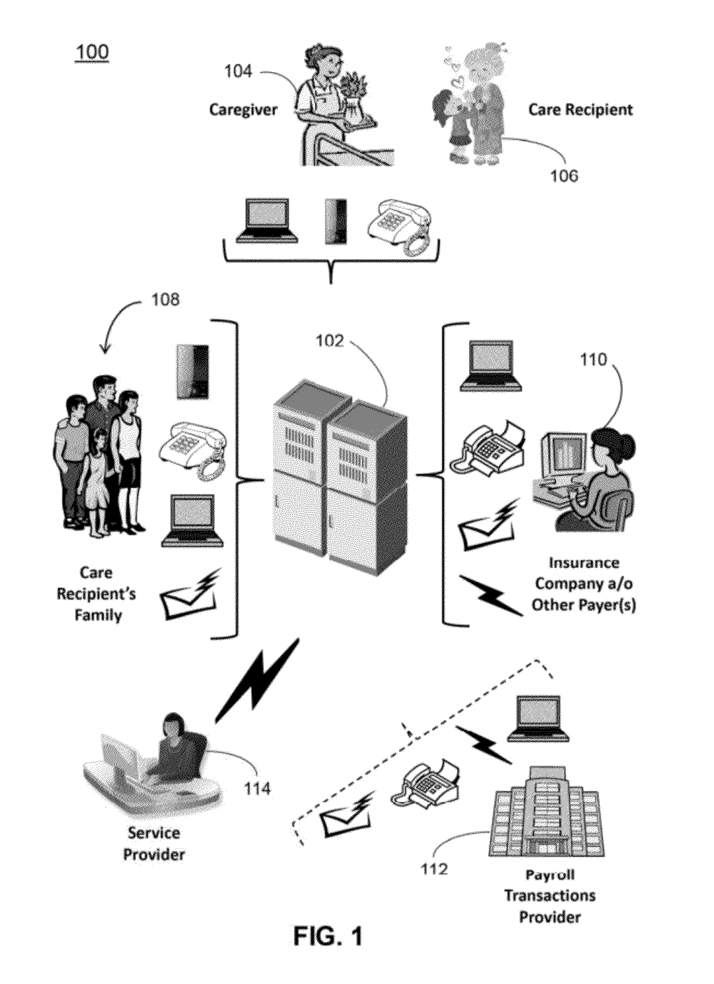

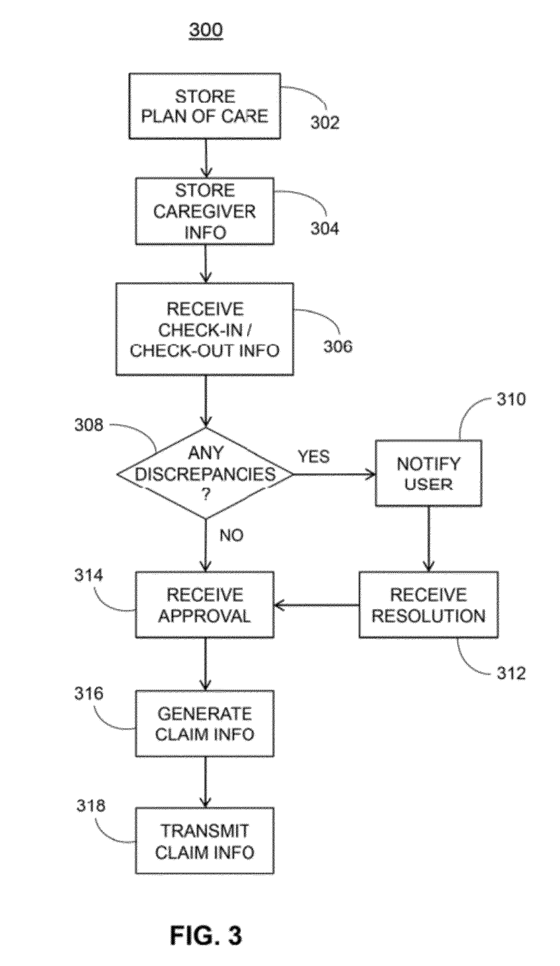

FIG. 1 shows an example of a generalized system 100 that can be used to implement an integrated timecard, quality assurance, and claim submission service in accordance with some embodiments. System 100 may include a computer 102, which may be a general purpose device or a special purpose device, such as a server in a client/server based environment. Computer 102 may be operative to provide (i.e., programmed or configured to perform) a timecard process, a quality assurance process, a claim submission process, and an optional payroll process, as described in more detail below in connection with FIGS. 3-6. Computer 102 may include any suitable components such as one or more hardware processors (each of which may be a microprocessor, digital signal processor, controller, etc.), memory, communication interfaces, networking devices, one or more storage devices at least one of which may be suitable for maintaining one or more database systems, display controllers, input/out devices, etc. In some embodiments, at least one hardware processor may have interactive voice response and/or voice recognition/pattern matching capabilities.

Computer 102 may have one or more interfaces for receiving communications from a caregiver 104. Caregiver 104 may access the timecard process of computer 102 to enter check-in/check-out information related to the services provided to a care recipient 106. In some embodiments, caregiver 104 may access the timecard process via a land-line telephone (at, e.g., the home of care recipient 106 or at a facility where care recipient 106 resides), a mobile phone, a smartphone, a personal digital assistant (PDA), a laptop, personal, or tablet computer, or any other suitable mechanism.

Computer 102 may have one or more interfaces for communicating with a care recipient's family 108 or other party responsible for the hiring of caregiver 104. The care recipient's family 108 or other responsible party may be considered to be the client of the integrated timecard, quality assurance, and claim submission service of system 100. In some cases, care recipient 106, if able and willing, may alternatively be the employer/client and, thus, the communication interfaces described herein apply to care recipient 106. In other cases, a caregiver agency may alternatively be the employer/client and, thus, the communication interfaces described herein apply to the caregiver agency (not shown). The timecard, quality assurance, claim submission, and/or optional payroll processes may automatically create various reports and/or notifications (described in more detail below) that are sent or made accessible to the care recipient's family 108 or other responsible party (e.g., a caregiver agency). For example, in some embodiments, the reports or notifications may identify discrepancies and deviations from an expected caregiver schedule or expected results, highlight missing caregiver entries or inaccurate information, indicate a caregiver's hours/days worked and activities performed, and/or provide any other information. In some embodiments, the care recipient's family 108 or other responsible party (e.g., a caregiver agency) may receive, for example, an email, automated phone message, or text message from computer 102 regarding or containing a notification, a report, and/or a direct link to address a specific discrepancy or to view a notification or report. In some embodiments, the care recipient's family 108 or other responsible party may additionally or alternatively have access to a report or notification on a website of system 100 via, for example, a laptop, personal, or tablet computer, a smartphone or PDA application, or any other suitable mechanism. Furthermore, the care recipient's family 108 or other responsible party may transmit information to computer 102. For example, in response to a report or notification, the care recipient's family 108 or other responsible party may provide information that corrects, updates, supplements, verifies, and/or approves information received or generated by the processes performed by computer 102. In some embodiments, the care recipient's family 108 or other responsible party may transmit information to computer 102 via, for example, email, telephone (e.g., via interactive voice prompts and recordings), laptop, personal, or tablet computer, smartphone, PDA, and/or any other suitable mechanism.

Computer 102 may have one or more interfaces for communicating with an insurance company or other payer(s) 110. For example, an insurance company or other payer(s) 110 may transmit an approved plan of care to computer 102 via, for example, direct electronic interface, web interface, fax, email, and/or any other suitable method. Furthermore, claim submission information generated by the claim submission process of computer 102 may be transmitted to the insurance company or other payer(s) 110 via, for example, direct electronic interface, web interface, fax, email, and/or any other suitable method. In some embodiments, for example, there may be a batch or real-time data feed between computer 102 and the insurance company or other payer(s) 110. Receipt of the information by the insurance company or other payer(s) 110 may be confirmed electronically via, for example, direct electronic interface, web interface, fax, email and/or any other suitable method.

In some embodiments in which the optional payroll process is provided, computer 102 may have one or more interfaces for communicating with a payroll transactions provider 112. Payroll transactions provider 112 may be, for example, an EFT (electronic funds transfer) or an ACH (automated clearing house) vendor that may perform bank money transfers based on the payroll information generated by computer 102. Generated payroll information may include information about, for example, withholdings, direct deposits, payment of taxes and fees, year-end statements and filings, and/or any other services related to the compensation of caregiver 104. The generated payroll information may be transmitted from computer 102 to payroll transactions provider 112 via, for example, direct electronic interface, web interface, fax, email, and/or any other suitable method. In some embodiments, for example, there may be a batch or real-time data feed between computer 102 and payroll transactions provider 112. Confirmation of the received information by payroll transactions provider 112 may be transmitted to computer 102 electronically via, for example, direct electronic interface, web interface, fax, email and/or any other suitable method. Note that, in some embodiments, payroll transactions may be performed by computer 102 and, thus, an interface with payroll transactions provider 112 may not be necessary.

Computer 102 may be operated by a service provider 114 of an integrated timecard, quality assurance, and claim submission service in accordance with some embodiments. Service provider 114 may have direct access to the timecard, quality assurance, claim submission, and optional payroll processes via, for example, an input/output device of computer 102. In some embodiments, service provider 114 may store into a database of computer 102 plan of care information received from insurance company 110 (if not automatically stored upon receipt via, e.g., uploading from an insurance company computer) and/or may store caregiver setup information received from care recipient 106, the care recipient's family 108, and/or caregiver 104. Service provider 114 may also, for example, enter information correcting, updating, supplementing, verifying, and/or approving information generated by the timecard, quality assurance, claim submission, and optional payroll processes that, for example, may have been received from care recipient 106 or the care recipient's family 108 in response to one or more reports and/or notifications.

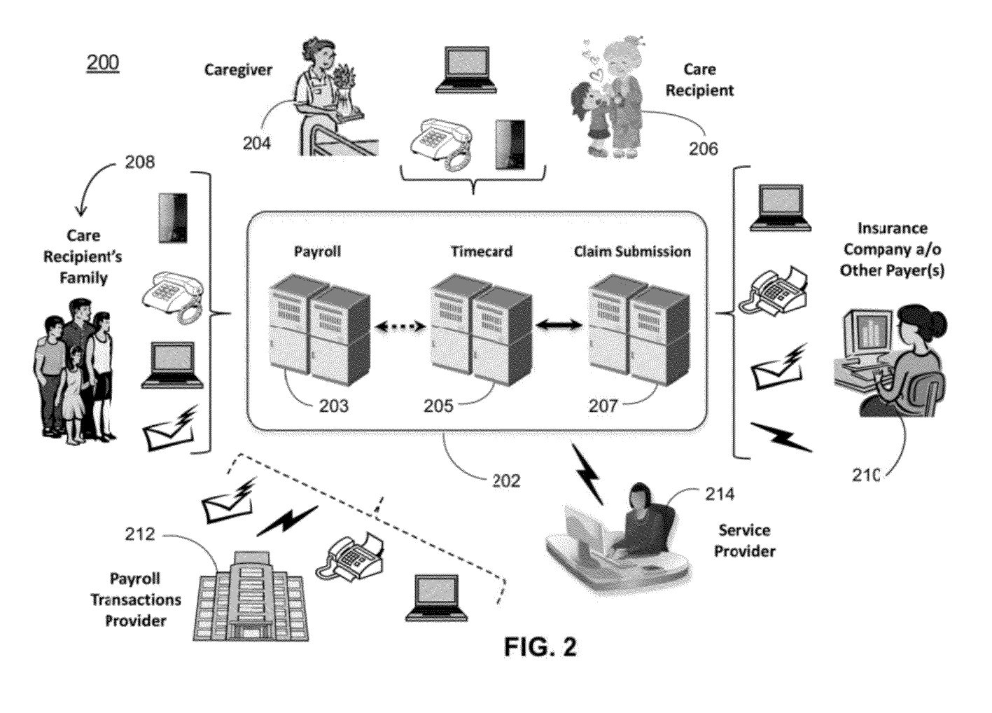

FIG. 2 shows an example of a system 200 that may additionally or alternatively be used to implement an integrated timecard, quality assurance, and claim submission service in accordance with some embodiments. System 200 may include an integrated computer system 202, which may include computers 203, 205, and 207. Computer 203 may be operative to provide a payroll process, which may be optional in some embodiments. Computer 205 may be operative to provide a timecard process, and computer 207 may be operative to provide a claim submission process. Integrated computer system 202 may be operative to provide a quality assurance process that, in some embodiments, may be performed exclusively by any one of computers 203, 205, or 207, or collectively by any combination of computers 203, 205, and 207. For example, each computer may perform a portion of the quality assurance process related to one of the payroll, timecard, or claim submission processes. Payroll, timecard, claim submission, and quality assurance processes in accordance with some embodiments are described in more detail below in connection with FIGS. 3-6.

In some embodiments, computers 203, 205, and 207 are integrated with each other (i.e., all are coupled to and in communication with each other). Each of computers 203, 205, and 207 may be, in some embodiments, a general purpose device or a special purpose device, such as, for example, a web or database server in client/server based environment. Furthermore, in some embodiments, each of computers 203, 205, and 207 may include any suitable components such as one or more hardware processors (which may be a microprocessor, digital signal processor, a controller, etc.), memory, communication interfaces, networking devices, one or more storage devices at least one of which is suitable for maintaining one or more database systems, display controllers, input/out devices, etc. In some embodiments, a hardware processor executing timecard process instructions may have interactive voice response and/or voice recognition/pattern matching capabilities.

In some embodiments, integrated computer system 202 may have one or more interfaces for communicating with each of a caregiver 204, a care recipient 206, the care recipient's family 208, an insurance company or other payer(s) 210, and a payroll transactions provider 212 (i.e., in some embodiments of computer system 202 providing a payroll service). The communication interfaces of computer system 202 may be identical or similar to those described above for the communication interfaces of computer 102 in system 100 (FIG. 1). For example, in some embodiments, caregiver 204 may access the timecard process in computer 205 via, for example, a land-line telephone (at, e.g., the home of care recipient 206), a mobile phone, a laptop, personal, or tablet computer, a smartphone, a PDA, or any other suitable mechanism to enter check-in/check-out information related to the services provided to care recipient 206. In some embodiments, care recipient 206 and/or the care recipient's family 208 or other responsible party (e.g., a caregiver agency) may exchange information with any of one of computers 203, 205, or 207 in connection with the timecard, claim submission, optional payroll, and quality assurance processes of computer system 202 via, for example, email, telephone (e.g., via interactive voice prompts and recordings), laptop, personal, or tablet computer, smartphone, PDA, and/or any other suitable mechanism. In some embodiments, insurance company or other payer(s) 210 may exchange information with computer 207 via, for example, direct electronic interface, web interface, fax, email, and/or any other suitable method. In some embodiments, for example, there may be a batch or real-time data feed between computer 207 and the insurance company or other payer(s) 210. And payroll transactions provider 212 (in some embodiments having a payroll computer 203 that provides a payroll service) may exchange information with computer 203 via, for example, direct electronic interface, web interface, fax, email, and/or any other suitable method. In some embodiments, for example, there may be a batch or real-time data feed between computer 203 and payroll transactions provider 212. Note that, in some embodiments, payroll transactions may be performed by computer 203 and, thus, an interface with payroll transactions provider 212 may not be necessary.

Integrated computer system 202 may be operated by a service provider 214 of an integrated timecard, quality assurance, and claim submission service in accordance with some embodiments. In some embodiments, service provider 214 may have direct access to the timecard, claim submission, optional payroll, and quality assurance processes via, for example, one or more input/output devices or interfaces of any one of computers 203, 205, and 207 as identically or similarly described to that above for computer 102 of system 100 (FIG. 1).

In some embodiments, the integrated timecard, quality assurance, and claim submission service may be a web-based, database centric, n-tier application written in .Net 4.0/C# using an SQL Server 2008R2 database engine and hosted on a Windows Server 2008R2 operating system. The application may run in a virtual Windows Server 2008R2 environment as well as a physical one. Note that, in some embodiments, implementations may be free of features that are dependent upon the use of an SQL Server 2008R2 as the database engine except the physical syntactical definition of the database structure, stored procedures, and triggers. In some embodiments, many of the configuration settings of the application may be setup specifically for an IIS (Internet Information Services) 7.5 Web server environment. In some embodiments, the web-based portion of the application may be HTML 5.0 compliant and may make use of Asynchronous Javascript calls in the user interface (UI) using standard .Net 4.0 functionality and a .Net community supported UI package called Ajax Control Toolkit, available from Microsoft's CodePlex website (http://www.codeplex.com/). The operating system may run on one or more Intel-based server(s) that may be provided by, for example, Dell, Inc. or Hewlett-Packard Company. In some embodiments, multiple redundant database and web servers may be used. A database server may be, for example, a dual-processor/quad-core Intel Xeon based system with 16 GB of RAM and 400 GB of disc space in a RAIDS configuration, and a Web server may be, for example, a dual-processor/dual-core Intel Xeon based system with 8 GB of RAM and 120 GB of disk space in a RAID5 configuration. In some embodiments, Linux servers or other types of hardware and software platforms may be used.

FIG. 3 illustrates an example of a flow diagram of a process 300 for implementing an integrated timecard, quality assurance, and claim submission service in accordance with some embodiments. As shown, at block 302, a hardware processor (of, e.g., computer 102 or integrated computer system 202) may store information regarding a plan of care for a care recipient. The plan of care may be pre-established before a caregiver is hired and may be preapproved by and received from an insurance company or other payer(s) (such as, e.g., insurance company 110 or 210 of FIGS. 1 and 2, respectively), a care recipient (such as, e.g., care recipient 106 or 206), a care recipient's family (such as, e.g., care recipient's family 108 or 208), or a caregiver agency. A plan of care may specify the living activities that a care recipient is to be assisted with by a caregiver, and may specify the number of hours per day and days per week during which the caregiver is to provide that assistance. For example, living activities that a care recipient may be assisted with may include any one or all of the following: bathing, dressing, transporting (e.g., to and from a doctor's office or physical therapy facility), continence, toileting, meal preparation and/or feeding, general supervision/safety, and/or any other appropriate activity, such as, for example, any ADL or IADL. A plan of care may specify, for example, that care is to be provided to a care recipient at the care recipient's home Monday through Friday, from 11:00 am to 8:00 pm. A plan of care may also specify whether the care of the care recipient is to be provided in the care recipient's home or at a care facility, and may include a list of approved caregivers. A plan of care may further specify, for example, the number of hours allowed per assisted activity and/or allowable expenses/mileage that may be incurred by a caregiver.

A plan of care may be received at the hardware processor in a manner and/or format such that, in some embodiments, the hardware processor is operative to automatically store information related to the plan of care in one or more databases of one or more storage devices (such as, e.g., one or more storage devices of computer 102 or computer system 202 of FIGS. 1 and 2, respectively). For example, the plan of care may be uploaded to the hardware processor from an insurance company or other payer computer via direct electronic access. Additionally or alternatively, in some embodiments, a service provider (such as, e.g., service provider 114 or 214 of FIGS. 1 and 2, respectively) may cause the hardware processor to store information related to a plan of care, which may have been received by email, fax, or some other means. In some embodiments, the hardware processor may automatically store one or more portions of the received plan of care, while the service provider may cause the hardware processor to store other portions of the received plan.

In some embodiments, the hardware processor may also store at block 302 customized claim submission information (described in more detail below in connection with block 316) for the insurance company or other payer(s) from which the plan of care was received. This information may specify the types of documents required to be submitted, the file formats of those documents, and the manner in which the claim submission documents are to be sent. For example, in some embodiments, claim submission information may be transmitted to an insurance company or other payer(s) via, for example, direct electronic interface, web interface, fax, email, and/or any other suitable method.

Next, at block 304, a hardware processor may store caregiver information related to the caregiver(s) hired to provide care services to the care recipient. The hardware processor may be the same processor used at block 302 or other suitable processor of, e.g., computer 102 or integrated computer system 202. The caregiver information may include, for example, the hired caregiver's name, identifier, and/or voice print (i.e., in some embodiments having voice recognition/pattern matching capabilities), a care recipient's name and/or identifier, the care recipient's home telephone number, address, and/or other location information, and/or the name and contact information of the care recipient's family or other party responsible for the hiring of the caregiver. In some embodiments, the caregiver information may include a caregiver work schedule and may be stored on a regular, periodic basis, such as for example, weekly, bi-weekly, or monthly. The caregiver information may also include whether the caregiver provides live-in (i.e., 24 hour/day) or hourly (i.e., less than 24 hour/day) care services to the care recipient. In the case of hourly care services, the caregiver's weekly schedule may be included in the caregiver setup information. The caregiver information may be received entirely or partially from the caregiver, the care recipient, or the care recipient's family or other party responsible for the hiring of the caregiver. The caregiver information may be received at the hardware processor in a manner and/or format such that, in some embodiments, the hardware processor is operative to automatically store the setup information in one or more databases of one or more storage devices. For example, caregiver information may be uploaded to the hardware processor via direct electronic access by a service provider, caregiver, care recipient, care recipient's family or other responsible party. Alternatively or additionally, for example, a caregiver may use an interactive voice response system of the service to input a voice print and other setup information, which is then automatically stored in an appropriate database. In some embodiments, a service provider may cause the hardware processor to store the setup information. In other embodiments, the hardware processor may automatically store one or more portions of the received caregiver information, while the service provider may cause the hardware processor to store other portions of the setup information.

At block 306, a hardware processor executing timecard process instructions may receive check-in/check-out information from a caregiver. This information may be received in some embodiments as services are provided to a care recipient. The hardware processor may be the same processor used at either block 302 or 304 or may be another suitable processor of, e.g., computer 102 or integrated computer system 202. In some embodiments, the caregiver may access the timecard process via, for example, a land-line telephone, a mobile phone, a smartphone, a PDA, a laptop, personal, or tablet computer, or any other suitable mechanism.

In those embodiments where the timecard process is accessible by telephone, the hardware processor executing the timecard process instructions may have interactive voice response capabilities that can answer the telephone call from the caregiver and prompt the caregiver to enter various information. The information may include, for example, a caregiver's identification number and voice input for recording and/or voice recognition, check-in/check-out indications, information about care provided, and/or any other relevant information. In some embodiments, relevant information may include a number of hours worked for each type of service or assistance provided, caregiver expenses, caregiver mileage, a description of services, a message to a care recipient's family or a caregiver's agency, and/or information regarding previous shifts worked. In some embodiments, a timecard process may communicate a message to a caregiver who has called in. For example, a timecard process may provide an outgoing message to a caregiver such as, for example, “you are missing a check out,” or “you worked 8 hours today.” In some embodiments, a timecard process may communicate a message to a caregiver from the caregiver's agency, a service provider, and/or a care recipient's family. A timecard process may, in some embodiments, provide an outgoing message to all caregivers regarding something applicable to all. In some embodiments, the hardware processor may receive the source telephone number of the caller pursuant to a caller identification capability, and may create a time/date stamp of the phone call. The hardware processor may be operative to store all of the received and created check-in/check-out information in a database of a storage device (of, e.g., computer 102 or integrated computer system 202). Note that as used herein, “check-in/check-out information” may include some or all of the information collected at block 306.

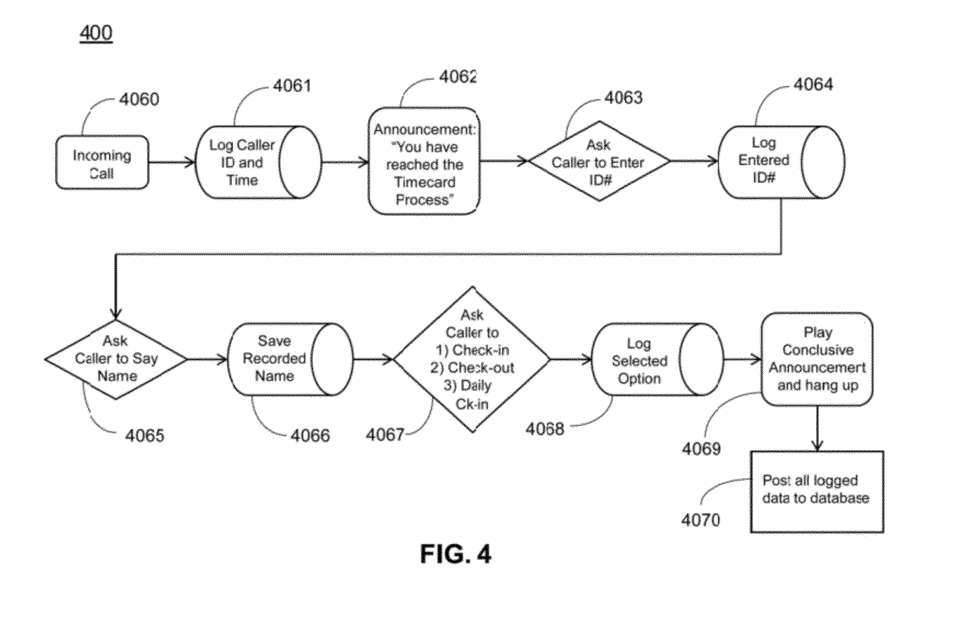

FIG. 4 illustrates an example of a telephonic check-in/check-out process 400 using an interactive voice response capability in accordance with some embodiments. As shown, at 4060, a caregiver may call a telephone call-in number of the timecard process. At 4061, the time card process may log the caller identification number of the telephone from which the caregiver is making the call and may log a time/date stamp of the call. The timecard process may answer the call at 4062 with an announcement identifying the timecard process. At 4063, the caregiver may be prompted to enter a caregiver identification number via a telephone keypad. The process may then repeat back to the caregiver the entered identification number and prompt the caregiver to press “1” on the keypad if correct or “2” on the keypad if incorrect. If “2” is entered, the process may again prompt the caregiver at 4063 to enter a caregiver identification number. In response to pressing “1,” the timecard process may log the entered identification number at 4064. The timecard process may then prompt the caregiver at 4065 to “record your name after the tone.” The process may then repeat back to the caregiver what the caregiver has recorded and prompt the caregiver to again press “1” if correct or “2” if incorrect. If “2” is entered, the process may repeat the prompt to record the caregiver's name. In response to pressing “1,” the timecard process at 4066 may save the recorded name. At 4067, the timecard process may prompt the caregiver to press “1” if recording a shift check-in, press “2” if recording a shift check-out, or press “3” if recording a daily check-in. A daily check-in is used in situations where the caregiver is providing live-in assistance (i.e., 24 hour/per day care) to a care recipient. In response to the caregiver pressing “1,” “2,” or “3,” the process may ask the caregiver to confirm the selection. In response to receiving the confirmation, the timecard process may log the selected option at 4068 and may confirm the selection and end the call at 4069. Note that in other embodiments, other keypad numbers or symbols may be used instead of “1,” “2,” and “3.”

In some embodiments, the timecard process may further voice prompt the caregiver upon check-out or daily check-in, as described above, to provide additional information, such as, for example, the living activities with which the caregiver assisted the care recipient, and/or any other appropriate information. For example, a caregiver may leave a voice message indicating that a care recipient requested additional care hours, approved an early departure by the caregiver, or refused assistance with a particular living activity. Additionally or alternatively, as described above, the timecard process may provide voice messages to a caregiver who telephonically accesses the timecard process.

In some embodiments, the information logged and saved at 4061, 4063, 4066, and 4068 may be written to a temporary file or other locations. When the call is complete, the timecard process may, at 4070, convert the contents of that temporary file to a format suitable for storage in a database.

The call flow of a telephonic timecard process may change, in some embodiments, from that described above in connection with process 400 depending on, for example, the caregiver calling in, a received caller identification number, an associated care recipient or caregiver agency, and/or an associated insurer or other payer. This may occur in cases where different check-in/check-out information needs to be collected.

In some embodiments in which the timecard process is accessed by a web application, such as, for example, via a smartphone, PDA, or laptop, personal, or tablet computer, the hardware processor executing timecard process instructions may receive information submitted by a caregiver via any suitable graphical user interface. The information received may include a caregiver's identification number, voice input for recording and/or voice recognition, shift check in/check out indications, information about care provided, and/or any other relevant information including, in some embodiments, the same information as described above in connection with telephonically accessing the timecard process. In some embodiments, a timecard process may provide communications to a caregiver as described above in connection with caregivers who telephonically access the timecard process. The hardware processor may also receive an internet protocol (IP) address (of the source device) of the interaction, and create a time/date stamp of the interaction. In some embodiments, the hardware processor may additionally or alternatively receive global positioning system (GPS) information from any suitably-equipped device used by a caregiver to submit check-in/check-out information. In some embodiments, location information (e.g., GPS information) may be received and/or monitored during any portion of a caregiver shift and/or at any point in time at which a caregiver interacts with the timecard process. The hardware processor may be operative to store all of the received and created information in a database of a storage device (of, e.g., computer 102 or integrated computer system 202).

In some embodiments, the hardware processor may generate comprehensive reports detailing hours worked by every employee (e.g., caregiver 104 or 204) for every employer/client (e.g., care recipient 106 or 206, care recipient family 108 or 208, or other responsible party). These reports may be accessible to a service provider (e.g., service provider 114 or 214), employers/clients, employees, agencies, and insurers or other payers (e.g., insurance company or other payers 110 or 210) through, for example, email, fax, web, smartphone or PDA application, and/or any other suitable mechanism.

To generate the comprehensive work reports, a hardware processor executing timecard process instructions may, in some embodiments, automatically associate check-in events and information with corresponding check-out events and information to create a ^{“}work shift.” The processor may compare multiple criteria to determine whether check-in and check-out events are related, including the event source, caller identification, caregiver identifier, shift check in/check out menu selection, sequence, time/day stamp, and/or any other relevant information. For example, a caregiver may access the timecard process telephonically from a home telephone of a care recipient at 7:00 am to check-in. A time/date stamp may be generated and a caller identification telephone number from the telephone used by the caregiver may be received by the hardware processor. In some embodiments, the processor may determine whether the received caller identification telephone number matches that of the home telephone of the appropriate care recipient based on the caregiver setup information stored at block 304. In some embodiments, the processor may also compare the caregiver's voice recording made during the 7:00 am check-in call with a voice print stored as part of the caregiver setup information. At the end of the shift, the caregiver may access the timecard process telephonically again from the care recipient's home phone at, for example, 3:00 pm to check-out. Again, a time/date stamp may be generated and a caller identification telephone number from the telephone used by the caregiver may be received by the hardware processor. The processor may again determine whether the received caller identification number matches that of the care recipient's home phone and, in some embodiments, may again compare the caregiver's voice recording made during the 3:00 pm check-out call with either the stored voice print, the voice print made at the 7:00 am check-in call, or both. Upon successfully passing these checks, the hardware processor may associate the 7:00 am check-in call with the 3:00 pm check-out call, determine that the caregiver worked 8 hours based on the time/date stamps of the check-in and check-out telephone calls, and accordingly create a work shift record for that day.

At block 308, one or more hardware processors may determine whether the received check-in/check-out information is complete and in conformance with the stored information regarding the plan of care and the stored caregiver information. In some embodiments, the one or more processors may additionally or alternatively determine whether there are questionable and/or unacceptable patterns in the received check-in/check-out information. Such patterns may, in some embodiments, indicate potential fraud or fraudulent behavior. Any of the one or more hardware processors may be a suitable processor used at block 302, 304, or 306 or may be another suitable processor of, e.g., computer 102 or integrated computer system 202. The one or more hardware processors executing quality assurance process instructions automatically determine whether there are discrepancies or deviations in the received caregiver check-in/check-out information and/or questionable and/or unacceptable patterns in the check-in/check-out information received over a period of time. In some embodiments, this process may be run on a once a day basis, a once a week or bi-weekly basis, an as-needed basis (e.g., as check-in/check-out information is received), or on any suitable schedule. The discrepancies or deviations may include, for example, check-in events without an associated check-out event and/or check-out events without an associated check-in event. Such discrepancies may occur, for example, when a caregiver accesses the timecard process to check-in at the start of a shift, but fails to access the timecard process to check-out at the end of the shift, and vice-versa. Such discrepancies may also occur when a caregiver accessing the timecard process to check-in inadvertently presses an incorrect number or symbol on a telephone keypad indicating a check-out, and vice-versa, resulting in back-to-back check-ins or check-outs.

Other discrepancies or deviations that, in some embodiments, the one or more hardware processors may determine include: (1) separate check-in and check-out events for a live-in caregiver who should have only daily check-ins and (2) daily check-ins for a caregiver who should have separate check-in and check-out events. These discrepancies may occur when a caregiver providing live-in assistance accesses the timecard process and inadvertently presses an incorrect number or symbol on a telephone keypad indicating, for example, a shift check-in instead of a daily check-in. Similarly, such discrepancies may occur when a caregiver providing assistance on an hourly basis accesses the timecard process and inadvertently presses an incorrect number or symbol on a telephone keypad indicating, for example, a daily check-in instead of a shift check-in or check-out.

Still other examples of discrepancies or deviations that, in some embodiments, may be determined by the one or hardware processors may include missing or incomplete care events where assistance with a certain number of living activities is expected but not reported. This may occur when a caregiver accesses the timecard process to indicate that assistance with three living activities was provided to a care recipient on a particular day, but stored information regarding the plan of care indicates that assistance with five living activities was required for that care recipient on that particular day. In some cases, for example, assisting with only 2 or 3 ADLs may be a trigger for an insurer that indicates that a care recipient may have recovered sufficiently to no longer be eligible for benefits under the care recipient's insurance policy.

Still more examples of discrepancies or deviations that, in some embodiments, may be determined by the one or hardware processors may include (1) missing care events where a caregiver is expected to work according to, e.g., a stored schedule (received at, e.g., 304) but checks-in late or not at all; (2) corresponding check-ins and check-outs with non-matching caller identification numbers or location information; (3) corresponding check-ins and check-outs with non-matching caregiver voice prints; and (4) check-ins or check-outs with incorrect caller identification numbers or location information.

At block 308, in some embodiments, a quality assurance process may additionally or alternatively analyze the received check-in/check-out data received over a period of time for questionable and/or unacceptable patterns. For example, a caregiver who fairly regularly fails to check in and check out on certain days of the week (e.g., Mondays or Fridays) may be identified. Caregivers who do not check in or check out properly more than a predetermined number of times over a given period of time may be identified. Other examples of questionable and/or unacceptable patterns may include: (1) reporting less hours worked than expected, (2) inconsistent information provided to a timecard process versus information submitted manually (e.g., on a log sheet), (3) consistent late check ins and/or late check outs, and (4) mismatched location information occurring more than a predetermined number of times over a given period of time may be identified. In some embodiments, the analysis may be performed weekly, bi-weekly, monthly, bi-monthly, or on any appropriate schedule.

In response to the one or more hardware processors determining at decision block 308 that there is at least one discrepancy or deviation in the received check-in/check-out information, process 300 may, in some embodiments, proceed to block 310. If no discrepancies or deviations are found at block 308, process 300 may proceed to block 314. In some embodiments, in accordance with rules of a quality assurance process, certain discrepancies or deviations may be deferred for resolution. In these cases, process 300 may proceed to block 314 instead of to block 310. For example, if a single missing check out were the only discrepancy found, process 300 may proceed to block 314. In some embodiments, the single check out discrepancy may proceed to block 310 either at a later time with other later found discrepancies or, in some embodiments, may proceed to block 310 in parallel with other check-in/check-out information being processed at block 314. In another example, quality assurance process rules may, in some embodiments, include time-based rules that may be based on, for example, a service level agreement. Thus, if a claim submission, for example, were due by a certain time or day, and a discrepancy were not resolved by then, process 300 may proceed to block 314 without resolving that discrepancy. Upon deferred resolution of a discrepancy, the relevant information associated with that resolved discrepancy may then be further processed in process 300.

At block 310, the one or more hardware processors executing quality assurance process instructions may, in some embodiments, generate a report of the determined discrepancies and deviations. The one or more hardware processors may further notify a user of the discrepancies or deviations found at decision block 308. Depending on the type of discrepancy or deviation, the user may be one or more of the service provider, the caregiver, the care recipient, the care recipient's family or other responsible party, and/or the insurance company or other payer(s). The one or more hardware processors executing quality assurance instructions may, in some embodiments, determine the appropriate action to take based on the type of discrepancy or deviation. Appropriate action may include, for example: (1) automatic notification of a service provider via any suitable one or more electronic methods, such as email, text messages, instant messages, automated telephone call, display of the generated report, etc.; (2) automatic notification of the care recipient's family or other responsible party via any suitable one or more electronic methods, such as email, text messages, instant messages, automated telephone call, etc.; (3) automatic notification of an insurer or other payer(s) via any suitable one or more electronic methods, such as email, text messages, instant messages, automated telephone call, etc.; and/or (4) automatic notification of a caregiver and/or caregiver agency via any suitable one or more electronic methods, such as email, text messages, instant messages, automated telephone call, etc.

For example, in some embodiments, the service provider may be notified of all determined discrepancies and deviations. In another example, if a determined discrepancy is a missing check-out or check-in event, or a daily check-in event instead of separate check-in and check-out events, the one or more hardware processors may, in some embodiments, automatically notify only the service provider and the caregiver. In a further example, if a determined discrepancy is an earlier than expected check-out time, or a less than expected number of living activities assisted with, the one or more hardware processors may, in some embodiments, automatically notify a service provider, a care recipient's family, and a caregiver and/or caregiver agency.

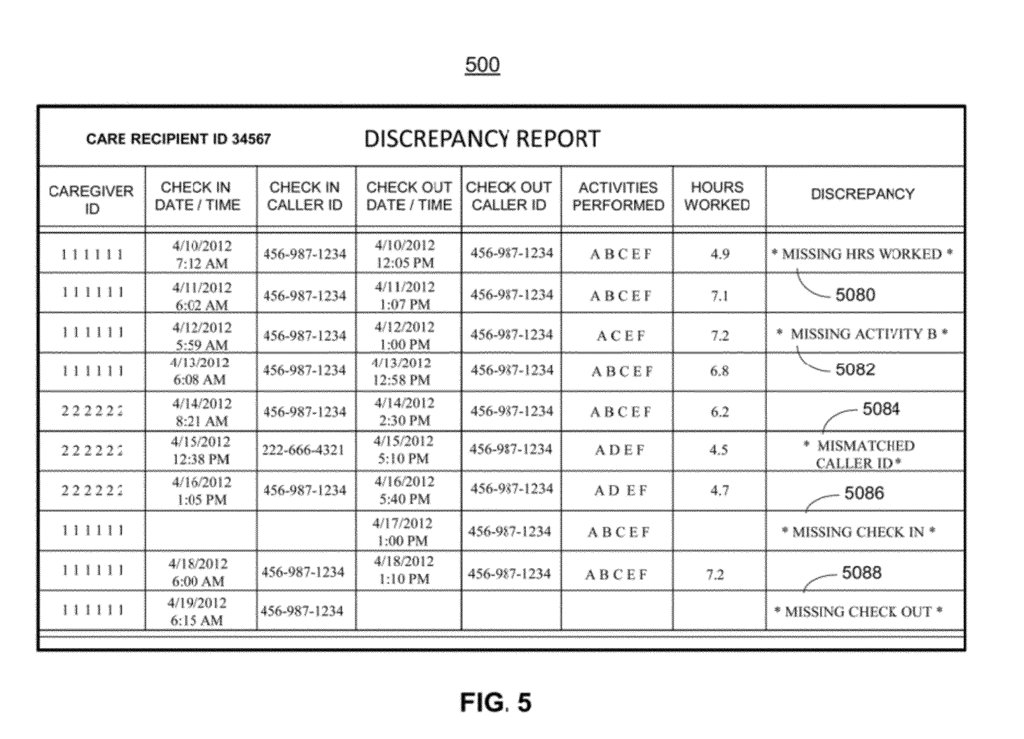

FIG. 5 shows an example of an illustrative discrepancy report 500 that may be generated by the one or more hardware processors in some embodiments. As shown, report 500 may cover a 10-day period for a care recipient having an identifier of 34567 and receiving care from two caregivers, a first caregiver having an identifier of 111111 and a second caregiver having an identifier of 222222. In some embodiments, reports may be generated by the one or more hardware processors that may cover various selectable time periods that may be, for example, one or more days, one or more weeks, and/or one or more months based on selectable dates and/or date ranges. Report 500 may show discrepancies in the check-in/check-out information received from two caregivers. Discrepancy 5080 may indicate that the hours worked on the indicated day by the first caregiver do not conform to the hours that should have been worked on that day as required by the stored plan of care. Discrepancy 5082 may indicate that a living activity “B,” which may be, for example, bathing, was not reported as having been performed by the first caregiver as required by the stored plan of care. Discrepancy 5084 may indicate that mismatched caller identifications were received when the second caregiver checked in and out. Discrepancy 5086 may indicate that the first caregiver failed to check in on the indicated day, and discrepancy may 5088 indicates that the first caregiver failed to check out two days later. Discrepancy reports may be (1) displayed on a display screen of an input/output device of, e.g., computer 102 or computer system 202, (2) accessible at a website of the service via, for example, a laptop, personal, or tablet computer, a smartphone or PDA application, or any other suitable mechanism, (3) attached to a notification email, (4) downloaded to a suitable user device as part of the notification process or as requested by a user, and/or (5) provided to a user in any other suitable manner.

At block 312, the one or more hardware processors may receive information from a user resolving the determined discrepancies and deviations. The user may be, for example, a service provider, a care recipient, a care recipient's family, and/or a caregiver and/or caregiver agency. For example, in response to a notification of discrepancies and deviations, a service provider may manually review a log sheet that the caregiver may have submitted in addition to providing the check-in/check-out information via the timecard process. The log sheet may indicate the dates and times worked and activities performed by a caregiver and may have been approved by the care recipient or care recipient's family prior to submission by the caregiver. The service provider may also compare the automatically determined discrepancies and deviations against the approved plan of care and/or any other information supplied by an insurer in an attempt to resolve the determined discrepancies. Upon resolving a discrepancy, such as, for example, by using the approved log sheet to resolve missing or mismatched check-in and check-out events, the service provider may enter the appropriate information, such as, for example, by editing the appropriate timecard process file(s) to correct, update, and/or supplement the received check-in/check-out information that resulted in the notification of discrepancies and deviations. In other situations, for example, a caregiver, a care recipient, and/or the care recipient's family may respond to a notification of discrepancies and deviations by providing information that corrects, updates, supplements, and/or acknowledges the determined discrepancies and deviations. The information from the caregiver, care recipient, and/or care recipient's family may be provided to the service provider via, e.g., email or fax, wherein the service provider may enter the received information. In some embodiments, users such as the caregiver, care recipient, and/or care recipient's family or other responsible party may provide information resolving one or more discrepancies by editing one or more appropriate files and then uploading the files to the one or more hardware processors or by editing the appropriate file(s) via, for example, a website of the service. In some embodiments, when a user logs onto a website or uses an application to provide updated information (e.g., corrections) in response to a discrepancy notification, that information may be noted in the quality assurance process as a “manual entry,” which may be distinct and discernible from information received via the timecard process. In some embodiments, the quality assurance process may have an “accept as is” feature to be used by one or more authorized users in those cases where the determined discrepancies and deviations are considered minor and/or inconsequential. Additionally or alternatively, based on quality assurance process rules, some discrepancies may not need to be resolved before process 300 can proceed to block 314. For example, a single missing check out may not prevent process 300 from proceeding to block 314. Upon later resolution of that missing check-out, the relevant information associated with that resolved check out may be further processed in process 300.

At block 314, the received check-in/check-out information received at block 306, or the check-in/check-out information updated at block 312 to resolve one or more discrepancies determined at block 308 may require user approval before process 300 may proceed to block 316, where claim submission information is generated. This may give a user an opportunity to, for example, manually review reports and information generated by the timecard and quality assurance processes, and/or may allow for additional timecard or quality assurance processing or other information to be received before proceeding with the claim submission process. User approval may be issued by the service provider, the caregiver, the care recipient, and/or the care recipient's family or other responsible party, as may be established by the service provider as part of an overall policy or as determined on a case by case basis where, for example, an employer/client may request that such a user approval be required. In some embodiments, a final quality assurance review may occur at block 314 (additionally or alternatively, a final quality assurance review may occur at block 312). In some embodiments, approval block 314 may be optional and may be omitted from process 300, in which case, process 300 proceeds automatically from the NO branch of decision block 308, and from block 312 directly to block 316 to generate claim submission information.

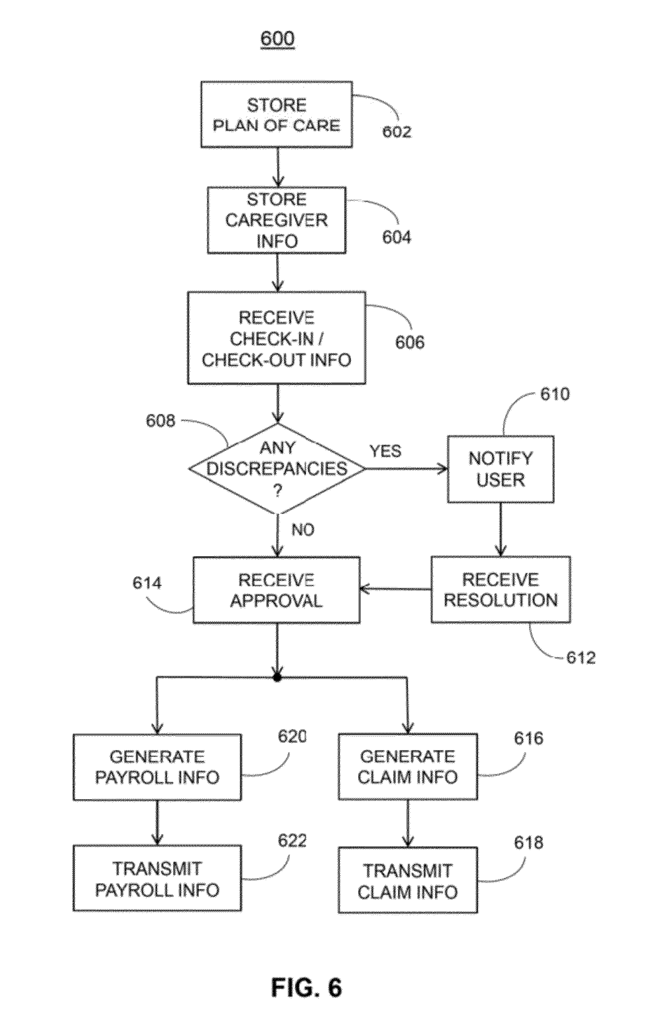

At block 316, one or more hardware processors may execute claim submission process instructions to generate claim submission information based on the received check-in/check-out information from block 306, the updated check-in/check-out information from block 312, or both. The one or more hardware processors may be any suitable processor used to perform one or more of the previously-described functions of process 300, or the one or more processors may be one or more other suitable processors of, e.g., computer 102 or integrated computer system 202. In some embodiments, the claim submission process may be run in accordance with a pre-approved schedule per insurance company or other payer(s), or on a weekly or bi-weekly basis, an as-needed basis (as check-in/check-out information is received), or on any other suitable schedule. In some embodiments, the claim submission process may generate various numbers of claim submission documents, invoices, and reports for each employer/client and employee/caregiver, depending on the submission requirements of that employer's/client's insurance company or other payer(s). Records indicating an insurer's and/or payer(s)' required submissions may be stored in a database for each employer/client (e.g., at block 302). In some embodiments, the documents, invoices and reports may be customized for each insurance company or payer. For example, the claim submission process may generate documents using an insurance company's or other payer(s)' pre-approved forms. Some of the documents required by various insurance companies and other payers may be, for example, caregiver log sheets, caregiver invoices, timecard process work reports, quality assurance summary or cover page, and/or discrepancy summary or cover page. Furthermore, different insurers may require different document content. For example, some insurers may require a detailed breakdown of caregiver hours worked, while others may only require a total number of caregiver hours worked. The forms, invoices, reports, and other required documents may be in electronic or paper form as required by the insurer and/or other payer(s). Claim submission information may be generated in various file formats, such as, for example, a coma separated values (CSV) file format, an image file format such as PDF (portable document format), or a page file format. For example, for one insurer, the claim submission process may generate and combine into one PDF claim submission file four different documents (each of which may be multiple pages). The four different documents may be automatically generated using multiple inputs and processes or they may be a manually prepared quality assurance check sheet (prepared by a service provider), a log sheet submitted by the caregiver and approved (e.g., signed) by a care recipient or the care recipient's family, a caregiver invoice, and a caregiver timecard process work report, the last two of which may be generated by either the timecard process or the claim submission process. In some embodiments also having a payroll process (e.g., as described below in connection with FIG. 6), invoices and claim forms for submission to an insurance company and/or other payer(s) may include documents describing all monies paid, including gross wages, state and federal taxes, state and federal fees, payroll fees and/or any other applicable charges or fees, and may include proofs of payment (e.g., cancelled checks) received by a service provider from a caregiver, caregiver agency, care recipient, and/or care recipient's family, as required by an insurer or other payer(s).

At block 318, a hardware processor may transmit claim submission information to an insurance company or other payer(s) in accordance with that insurer's or payer(s)' requirements. These requirements may include the use of an appropriate transmission protocol. For example, in some embodiments, claim submission information may be transmitted via Secure FTP (File Transfer Protocol), Secure Copy (SCP protocol), or Hypertext Transfer Protocol Secure (HTTPS). The transmission may occur automatically pursuant to a schedule or interface agreement, manually via a prompt by a user or some other trigger, and/or on any other suitable basis. Transmission may occur via direct electronic interface, web interface, fax, and/or any other suitable method in accordance with an insurer's or payer(s)' requirements. Records indicating an insurer's and/or payer(s)' required manner of transmission may be stored in a database for each employer/client (e.g., at block 302). Receipt of claim submission information by the insurer or other payer(s) may be confirmed electronically, via direct electronic interface, web interface, fax, email and/or any other suitable method, or manually via web interface, fax, phone, email and/or any other suitable method.

FIG. 6 illustrates an example of a flow diagram of another process for implementing an integrated timecard, quality assurance, and claim submission service in accordance with some embodiments. In contrast to process 300, process 600 includes a payroll process. One or more hardware processors performing process 600 may perform the functions of blocks 602, 604, 606, 608, 610, 612, 614, 616, and 618 in a manner similar or identical to that of blocks 302, 304, 306, 308, 310, 312, 314, 316, and 318 of process 300.

At block 620, a hardware processor may execute payroll process instructions to generate payroll information. Generated payroll information may include information about, for example, gross wages, withholdings, direct deposits, payment of taxes and fees, year-end statements and filings, and/or any other services related to the compensation of caregiver. In some embodiments, the payroll process may determine when a payroll should be run for each employer/client based on the employer's/client's last payroll date and the frequency of payroll. Payroll frequency can be weekly, bi-weekly, semi-monthly, monthly, ad-hoc or other frequency as requested by the employer/client. In some embodiments, the process can generate the payroll amounts to be paid based on timecard process results and/or other applicable factors. The payroll process may be accessed via any suitable one or more electronic means, including web-based, smartphone application and/or other suitable mechanism. Timecard process information and other payroll details (e.g., hourly wage rates, overtime rates, etc.) can be loaded into the payroll hardware processor automatically or manually, and this can trigger multiple actions within the payroll process, such as, for example: (1) the employer/client and/or designee(s) may be notified of payroll details and amounts via an electronic interface and/or any other applicable mechanism; (2) the employer/client and/or designee(s) may have access to view and change payroll details and amounts via an electronic interface and/or any other applicable mechanism; (3) the information can be stored and retained within a database and may be accessible by a service provider via one or more suitable reports and/or electronic interfaces; and/or (4) the payroll process may perform standard payroll operations according to an appropriate schedule, including generation of information regarding transfer of net pay from employer/client to employees (e.g., caregivers), withholding of income taxes, payment of employer taxes, payment of federal and state fees, payment of payroll fees, printing of receipts and check statements, and/or any other suitable payroll processes.

Additionally, at block 620, the payroll process may, in some embodiments, generate reports of payroll results for individual employers/clients and their caregivers for use in a detailed quality assurance review in addition to those performed at blocks 608 and 614. Results from the timecard and payroll processes may be compared against each other for accuracy, may be compared against log sheets submitted by the caregivers, and may be compared against the approved plan of care and/or any other information supplied by an insurer.

At block 622, the generated payroll information may be transmitted to a third party payroll transactions provider, such as, for example, payroll transactions providers 112 and 212 of FIGS. 1 and 2, respectively. A third party payroll transactions provider may perform the bank money transfers between accounts based on the generated payroll information. The generated payroll information may be transmitted to the payroll transactions provider via, for example, direct electronic interface, web interface, fax, email, and/or any other suitable method. Records indicating a payroll transactions provider's required manner of transmission may be stored in a database. Confirmation of the received information by payroll transactions provider may be transmitted to the hardware processor electronically via, for example, direct electronic interface, web interface, fax, email and/or any other suitable method. In some embodiments, payroll transactions may be performed at block 620 by the payroll process and, accordingly, block 622 may be omitted from process 600.

Note that the steps of the flow diagrams in FIGS. 3, 4, and 6 may be executed or performed in an order or sequence other than the order and sequence shown in the FIGS and described above. For example, some of the steps may be executed or performed substantially simultaneously or in parallel where appropriate to reduce latency and processing times.

Note also that in some embodiments the timecard, claim submission, and quality assurance processes are not necessarily each separate processes with defined boundaries, but may be part of a single integrated process.

In accordance with some embodiments, any of the devices described herein may be any of a general purpose device such as a computer or a special purpose device such as a client, a server, phone, smartphone, mobile phone, web browsing appliance, fax machine, etc. Any of these general or special purpose devices may include any suitable components such as a hardware processor (which may be a microprocessor, digital signal processor, a controller, etc.), memory, communication interfaces, display controllers, input devices, etc.

In some embodiments, any suitable computer readable media may be used for storing instructions for performing the processes described herein. For example, in some embodiments, computer readable media may be transitory or non-transitory. For example, non-transitory computer readable media may include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media may include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention may be made without departing from the spirit and scope of the invention, which is only limited by the claims which follow. Features of the disclosed embodiments may be combined and rearranged in various ways.

What is claimed is:

1. A method of administering a plan of care for a care recipient, the method comprising:
storing in one or more storage devices information regarding a plan of care for a care recipient and caregiver information associated with the plan of care;
receiving at one or more hardware processors check-in/check-out information initiated by the caregiver regarding caregiver services for the care recipient, at least one of the one or more hardware processors having interactive voice response or voice recognition/pattern matching capabilities;
the one or more hardware processors generating claim submission information based on the received check-in/check-out information in accordance with an insurer's or payer's requirements; and
the one or more hardware processors transmitting the claim submission information to the insurer or payer of the caregiver services in accordance with the insurer's or payer's requirements.

2. The method of claim 1 wherein the storing in one or more storage devices of information regarding a plan of care comprises storing in one or more storage devices information including at least one of a care recipient identifier, a number of caregiver hours to be worked in a day, a number of caregiver days to be worked in a week, or an indication of at least one type of daily activity with which the care recipient is to be assisted.

3. The method of claim 1 wherein the storing in one or more storage devices of caregiver information comprises storing in one or more storage devices at least one of a caregiver identifier and a voice print of the caregiver's voice.

4. The method of claim 1 wherein the receiving at one or more hardware processors check-in/check-out information comprises at least one of:
receiving telephonically at the one or more hardware processors check-in time information from the caregiver regarding the caregiver services, the check-in time information including at least one of a caregiver identifier or a voice input comprising the caregiver's spoken name;
receiving telephonically at the one or more hardware processors check-out time information from the caregiver regarding the caregiver services, the check-out time information including at least one of a caregiver identifier, a voice input comprising the caregiver's spoken name, or information about services provided; or
receiving at the one or more hardware processors automated time/date stamp information or location information, the location information indicating a source telephone number, an Internet Protocol address, or information from a global positioning system.

5. The method of claim 1 further comprising:
the one or more hardware processors determining whether the received check-in/check-out information is complete and in conformance with the stored information regarding the plan of care and the stored caregiver information or whether a pattern related to the received check-in/check-out information is questionable;
the one or more hardware processors notifying a user of one or more discrepancies in the received check-in/check-out information in response to the one or more hardware processors determining that the received check-in/check-out information is not complete or does not conform to the stored information regarding the plan of care or to the stored caregiver information, or that the pattern related to the received check-in/check-out information is questionable; and
receiving at the one or more hardware processors information resolving the one or more discrepancies in response to the notifying of a user to create updated check-in/check-out information;

6. The method of claim 5 wherein the one or more hardware processors determining whether the received check-in/check-out information is complete and in conformance with the stored information regarding the plan of care and the stored caregiver information comprises determining whether:
a check-in event has a corresponding check-out event;
a check-out event has a corresponding check-in event;
a received voice input of a caregiver's voice matches a voice print of the caregiver stored in the one or more storage devices;
received location information matches location information as indicated in the information regarding the plan of care stored in the one or more storage devices or in the caregiver information stored in the one or more storage devices; or
a number of hours worked as determined by the one or more hardware processors matches a planned number of hours to be worked as indicated in the stored information regarding the plan of care.

7. The method of claim 5 wherein the notifying of a user comprises at least one of:
presenting on a display screen a notification of one or more discrepancies;
emailing to a user notification of one or more discrepancies;
sending a text message to a user regarding one or more discrepancies;
sending an instant message to a user regarding one or more discrepancies; or
telephoning an automated message to a user regarding one or more discrepancies.

8. The method of claim 1 wherein the one or more hardware processors generating claim submission information in accordance with an insurer's or payer's requirements comprises generating claim submission information in one of a coma separated values (CSV) file format, an image file format, or a page file format.

9. The method of claim 1 wherein the one or more hardware processors transmitting the claim submission information to the insurer or payer of the caregiver services in accordance with the insurer's or payer's requirements comprises transmitting the claim submission information via one of fax, secure copy (SCP) protocol, hypertext transfer protocol secure (HTTPS), or secure file transfer protocol (FTP).

10. The method of claim 1 further comprising generating payroll information based on the received check-in/check-out information.

11. The method of claim 10 wherein:
the receiving of check-in/check-out information is performed by a first processor of the one or more hardware processors; and
the generating of claim submission information and the transmitting of the claim submission information is performed by a second processor of the one or more hardware processors; and
the generating of payroll information is performed by a third processor of the one or more hardware processors.

12. A system for administering a plan of care for a care recipient, the system comprising:
one or more storage devices for storing information regarding a plan of care for a care recipient and for storing caregiver information associated with the plan of care; and
one or more hardware processors coupled to the one or more storage devices, at least one of the one or more hardware processers having interactive voice response or voice recognition/pattern matching capabilities, the one or more hardware processors operative to:
receive check-in/check-out information initiated by the caregiver regarding caregiver services for the care recipient;
determine whether the received check-in/check-out information is complete and in conformance with the stored information regarding the plan of care and the stored caregiver information or whether a pattern related to the received check-in/check-out information is questionable;
notify a user of one or more discrepancies in the received check-in/check-out information in response to determining that the received check-in/check-out information is not complete or does not conform to the stored information regarding the plan of care or to the stored caregiver information, or that the pattern related to the received check-in/check-out information is questionable;
receive information from the user resolving the one or more discrepancies to create updated check-in/check-out information;
generate claim submission information based on the received check-in/check-out information, the updated check-in/check-out information, or both in accordance with an insurer's or payer's requirements; and
transmit the claim submission information to the insurer or payer of the caregiver services in accordance with the insurer's or payer's requirements.

13. The system of claim 12 wherein the one or more processors comprises:
a first processor operative to receive the check-in/check-out information and to determine whether the received check-in/check-out information is complete and in conformance with the stored information regarding the plan of care and the stored caregiver information; and
a second processor in communication with the first processor, the second processor operative to generate and transmit the claim submission information in accordance an insurer's or payer's requirements.

14. The system of claim 12 wherein the one or more processors are further operative to generate payroll information based on the received check-in/check-out information, the updated check-in/check-out information, or both.

15. The system of claim 14 wherein the one or more processors comprises:
a first processor operative to receive the check-in/check-out information and to determine whether the received check-in/check-out information is complete and in conformance with the stored information regarding the plan of care and the stored caregiver information; and
a second processor in communication with the first processor, the second processor operative to generate and transmit the claim submission information in accordance an insurer's or payer's requirements; and
a third processor in communication with the first processor, the third processor operative to generate the payroll information.

16. The system of claim 12 wherein the one or more processors operative to determine whether the received check-in/check-out information is complete and in conformance with the stored information regarding the plan of care and the stored caregiver information are operative to determine whether:
a check-in event has a corresponding check-out event;
a check-out event has a corresponding check-in event;
a received voice input of a caregiver's voice matches a voice print of the caregiver stored in the one or more storage devices;
received location information matches location information as indicated in the stored information regarding the plan of care or in the stored caregiver information; or
a number of hours worked as determined by the one or more hardware processors matches a planned number of hours to be worked as indicated in the information regarding the plan of care stored in the one or more storage devices.

17. The system of claim 12 wherein the one or more processors operative to notify a user of one or more discrepancies in the received check-in/check-out information are operative to:
present on a display screen a notification of one or more discrepancies;
email to a user notification of one or more discrepancies;
send a text message to a user regarding one or more discrepancies;
send an instant message to a user regarding one or more discrepancies; or
telephone an automated message to a user regarding one or more discrepancies.

18. A non-transitory computer-readable medium containing computer-executable instructions that, when executed by a processor, cause the processor to perform a method of administering a plan of care for a care recipient, the method comprising:
receiving check-in/check-out information initiated by a caregiver regarding caregiver services for a care recipient;
determining whether the received check-in/check-out information is complete and in conformance with stored information regarding a plan of care and stored caregiver information associated with the plan of care or whether a pattern related to the received check-in/check-out information is questionable;
notifying a user of one or more discrepancies in the received check-in/check-out information in response to determining that the received check-in/check-out information is not complete or does not conform to the stored information regarding the plan of care or to the stored caregiver information, or that the pattern related to the received check-in/check-out information is questionable;
receiving information resolving the one or more discrepancies in response to the notifying of a user to create updated check-in/check-out information;
generating claim submission information based on the received check-in/check-out information, the updated check-in/check-out information, or both in accordance with an insurer's or payer's requirements; and
transmitting the claim submission information to the insurer or payer of the caregiver services in accordance with the insurer's or payer's requirements.

19. The non-transitory computer-readable medium of claim 18 wherein the method comprising the notifying of a user comprises at least one of:
presenting on a display screen a notification of one or more discrepancies;
emailing to a user notification of one or more discrepancies;
sending a text message to a user regarding one or more discrepancies;
sending an instant message to a user regarding one or more discrepancies; or telephoning an automated message to a user regarding one or more discrepancies.

20. The non-transitory computer-readable medium of claim 18 wherein the method further comprises generating payroll information based on the received check-in/check-out information, the updated check-in/check-out information, or both.
